(19) United States
(12) Patent Application Publication
(10) Pub. No.: US 2005/0046831 A1
(43) Pub. Date: Mar. 3, 2005

(54) Method and apparatus for real-time detection of wafer defects

(75) Inventor: Chih-Kun Chen, Taoyuan (TW)

Correspondence Address: QUINTERO LAW OFFICE, 1617 BROADWAY, 3RD FLOOR, SANTA MONICA, CA, 90404, US

(73) Assignee: Nanya Technology Corporation

(21) Appl. No.: 10/715,680

(22) Filed: Nov. 18, 2003

(30) Foreign Application Priority Data
Aug. 29, 2003 (TW) 92123882

(51) Int. Cl. G01N 21/88

(52) U.S. Cl. 356/237.2

(57) ABSTRACT

A method and apparatus for real-time detection of wafer defects. A method for real-time detection of wafer defects comprises the steps of providing a desired wafer before or after a predetermined fabrication step and obtaining optical information thereof and comparing and analyzing the optical information of the desired wafer with corresponding reference information for instantaneously detecting possible wafer defects, wherein a predetermined action is performed upon detection of wafer defects.

### BACKGROUND OF THE INVENTION

1. Field of the Invention

The present invention relates to a method for real-time detection of wafer defects and an apparatus for the same, and in particular to a method for real-time detection of wafer defects during semiconductor processes and an apparatus of the same.

2. Description of the Related Art

In integrated circuit (IC) and semiconductor manufacturing, fabrication steps such as film deposition, planarization, lithography and etching are repeatedly performed. In most IC and semiconductor industries, the described fabrication steps are introduced into a successive type process using transferring mechanisms such as transmissions or robot arms to successively transfer substrates or semi-finished substrates into manufacturing apparatuses of each process area and conditions of each process such as temperature, gas ratios or pH therein are synchronized with the described fabricating steps. Goals of massive fabrication and yield improvement can thus be achieved through a series of designed processes for reducing manufacturing time of the formed devices.

Aggressive yield increases and cost reductions can be achieved by introducing the successive type process to the modern IC and semiconductor manufacturing, however, the substrates or the semi-finished substrates must be transferred into a manufacturing apparatus, and a series of fabrication steps must be then performed until all the fabrication steps are completed. Once deviations such as an abnormal film thickness, un-deposited film and over or insufficient (chemical mechanical polishing) CMP caused by the manufacturing apparatus or other defects occur, resulting in wafer abnormalities, or void formations. Once the void wafer travels to the subsequent fabrication steps, time and yield reductions occur due to the fact that defective wafers have been transported to the next fabrication step. In addition the sequence of fabrication steps may be disordered, resulting in damage to fabrication equipment.

Using the dynamic random access memory (DRAM) process as an example, tens of film deposition steps are normally required to form films of various designs a substrate. When a silicon substrate proceeds to the DRAM process, if any of the film depositions therein is not properly performed or if an abnormal thickness is found, for example an un-deposited metal line during filling of the metal layer when forming bit-line contact holes, seriously affects the subsequent fabrication steps. Fabrication costs and lost manufacturing time result. In addition, disorder of a subsequent fabrication step such as an etching step for bit-line metal layer and contamination of the reaction chamber thereof can also occur. When the described abnormal situation of an un-deposited metal layer within the bit-line contact hole can be previously determined through a method or an apparatus. The abnormal wafer can thus be held back from subsequent fabrication steps and in-line operators can be simultaneously notified to fix the problem. Once the described situation is resolved, the abnormal wafer can proceed to subsequent fabrication steps thereby preventing down time, equipment damage or reduced yield.

Hence, there is a need for a method or an apparatus for detecting void wafers and other abnormalities before or after certain fabrication steps to reduce waste and semiconductor fabrication cost, thus improving process stability and device yield.

### SUMMARY OF THE INVENTION

Accordingly, an object of the invention is to provide a method and an apparatus for real-time detection of wafer defects, applicable to a successive type semiconductor process, to detect abnormal wafers before said wafers proceed to subsequent fabricating steps.

To achieve the described object, the present invention provides a method for real-time detection of wafer defects, comprising the steps of providing a desired wafer before or after a predetermined fabrication step and obtaining optical information thereof and comparing and analyzing the optical information of the desired wafer with corresponding reference information for instantaneously detecting possible wafer defects, wherein a corresponding action is performed upon detection of wafer defects.

In the method of the invention, an optical detecting unit is used for detecting the desired wafer to obtain optical information thereof and a process control unit is used for comparing and analyzing the optical information of the desired wafer.

In the method for real-time detection of wafer defects of the invention, the optical detecting unit is an image capture device and the optical information is film color information. The film color information is compared with corresponding reference film color information to instantaneously determine whether defects are present.

In the method for real-time detection of wafer defects of the invention, at least one light source is used during the step of obtaining optical information of the desired wafer and comparing and analyzing the optical information thereof with corresponding reference information for instantaneously detecting possible wafer defects.

In addition, the present invention provides an apparatus for real-time detection of wafer defects, the apparatus comprises an optical detection device for detecting a desired wafer after different processes or before processing for gathering optical information thereof and a process control unit for comparing and analyzing the optical information of each with corresponding reference information to instantaneously detect possible wafer defects, wherein a predetermined action is performed by the processing unit when possible wafer defects are detected.

In the apparatus for real-time detection of wafer defects of the invention, at least one light source is provided to illuminate the desired wafer and the optical detection device can be an optical intensity measuring device for gathering reflection intensity information from the surface of the desired wafer.

In one preferred embodiment of the invention, an alarm is provided and triggers an alert signal when possible wafer defects are detected.

### BRIEF DESCRIPTION OF THE DRAWINGS

The present invention can be more fully understood by reading the subsequent detailed description and examples with references made to the accompanying drawings, wherein:

FIG. 1 is a flowchart illustrating a process flow of the real-time detection of wafer defects according to the present invention;

FIG. 2 is a diagram illustrating an apparatus for a real-time detection of wafer defects according to the first embodiment;

FIG. 3 is a diagram illustrating another apparatus for a real-time detection of wafer defects according to the second embodiment;

FIG. 4 is a diagram illustrating a designed apparatus for the real-time detection of wafer defects in combination with a manufacturing apparatus.

### DETAILED DESCRIPTION OF THE INVENTION

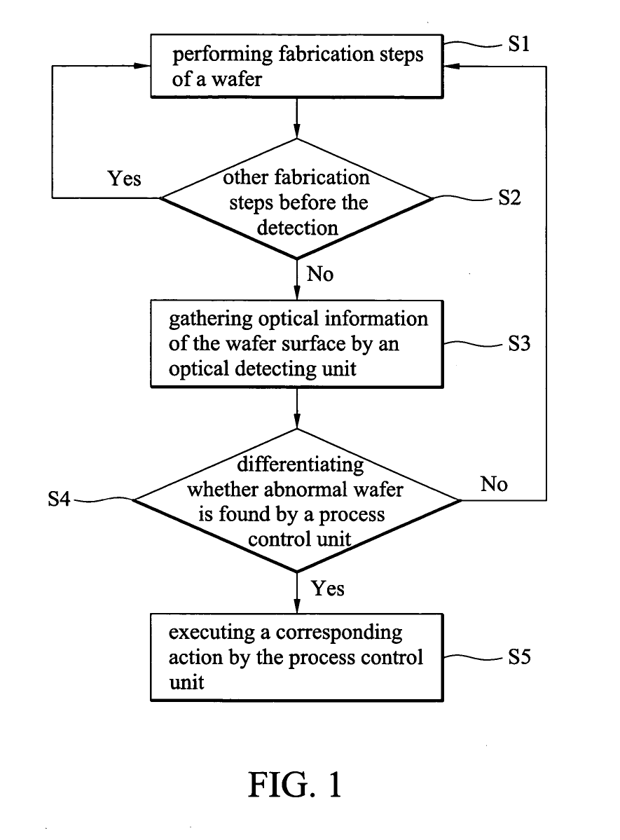

FIG. 1 is a flowchart illustrating a process flow of the real-time detection of wafer defects according to the present invention.

First, in step S1, a wafer performs fabrication steps of a particular process. Next, step S2 determines whether other fabrication steps must be performed before wafer detection. If so, steps S1˜S2 are repeated. If not, wafer detection is then performed using an optical detecting unit to gather optical information about the wafer surface, shown in step S3. Next, step S4 determines whether the wafer is abnormal by comparing the gathered optical information from the wafer with corresponding reference optical information of a normal wafer from a process control unit. If not, steps S1˜S2 are repeated and subsequent fabrication steps are performed. If so, a corresponding predetermined action such as exerting triggering an alarm to notify in-line operators can be performed by the process control unit to warn of the described abnormality, as shown in step S5.

Additionally, first and second embodiments are preferred embodiments of the invention, respectively illustrating methods for the real-time detection of wafer defects of the invention by different optical apparatuses.

### First Embodiment

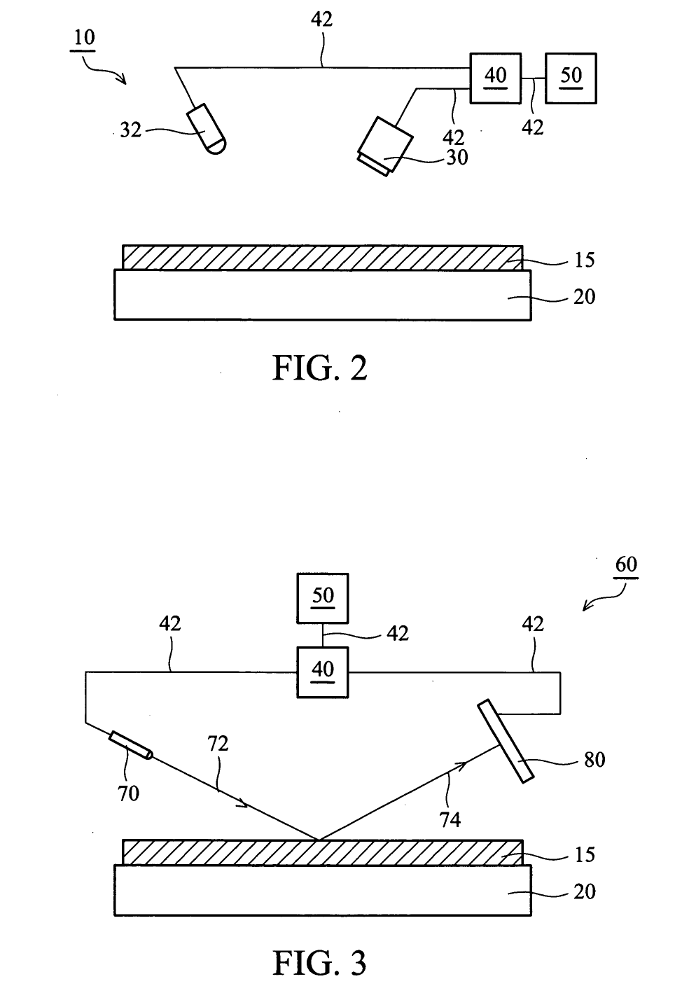

As shown in FIG. 2, a diagram of an apparatus for real-time detection of wafer defects using an image capture device as the optical detecting unit is illustrated. In this embodiment, the image capture device acting as an optical detecting unit can be constituted by one or several charged-couple devices (CCDs) and film information such as color information on a desired wafer for detection can thus be gathered by the CCDs. Through comparisons between the film information (e.g. film color information) and corresponding reference film information (e.g. film color information), whether the desired wafer is abnormal or not can be instantaneously detected.

An apparatus 10 for real-time detection of wafer defects shown in FIG. 2 includes a wafer disposition portion 20 for receiving a desired wafer 15, an image capture device 30 as an optical detecting unit and a process control unit 40. According to requirements, the apparatus 10 for real-time detection of wafer defects has at least one light source 32, an alarm trigger 50, and connection lines 42 to respectively connect the light source 32, the image capture device 30 and the alarm trigger 50 with the process control unit 40.

Next, a desired wafer 15 for detection is disposed on the wafer disposition portion 20 and the wafer disposition portion 20 which can be, for example, a measurement platform. The desired wafer is then transferred onto the measurement platform through a proper transmission before of after a predetermined process step. A transmission, for example a robot arm having more than one clamping apparatus for performing wafer-in and wafer-out after a predetermined process step is completed, can directly act as the wafer disposition portion 20 in the present invention.

Next, the light source 32 illuminates the desired wafer 15 to a certain intensity the image capture device 30, acting as an optical detection unit. Film information, for example color information, of the surface of the desired wafer 15 is then gathered by the image gathering device 30. The light source 32 can be, for example, a visible light source, a monochromatic light source or a white light source corresponding to different types of the desired wafer 15. The image capture device 30 can constitute at least one CCD to gather the film information at each portion of the desired wafer 15.

After gathering the film information from the surface of the desired wafer 15 with the image capture device 30, the image capture device 30 then transfers the gathered film information to the process control unit 40 for comparison with corresponding reference film information and instantaneous analysis thereof can be performed to determine whether or not the desired wafer is abnormal. The apparatus 10 for real-time detection of wafer defects of the invention can further include an alarm trigger 50 such as an alarm trigger connected to the process control unit 40 to send alert signal indicating detection of an abnormal wafer. The alarm trigger 50 here can be a warning tower or a buzzer.

The described illustrations of the invention can be applied to practical semiconductor processes such as abnormal wafer detection during the deposition of the bit-line formation. For example, in a DRAM process, a composite layer of titanium and titanium nitride (Ti/TiN) is deposited on the wafer before deposition of tungsten (W) to prevent peelings of the deposited tungsten layer. Here, film color of the deposited Ti/TiN layer is golden and he described method can thus be applied to differentiate the film color information of a desired wafer before tungsten deposition. Once the film color is determined to be golden, the desired wafer is determined as normal and the subsequent tungsten deposition continues. Conversely, once the desired wafer is detected as abnormal, the process control unit 40 performs a predetermined action such stopping wafer transmission and alerting in-line operators with the alarm trigger 50. The method for real-time detection of wafer defects using an image capture device such as an optical detecting device can be also applied to detecting wafer abnormalities during tungsten deposition (or a CMP process thereof) according to the gray film color of the deposited tungsten. Through the comparison of film color information by the method illustrated of this embodiment, one can instantaneously determine whether tungsten has been deposited on the wafer with formed Ti/TiN or not.

### Second Embodiment

In FIG. 3, a diagram of an apparatus 60 for real-time detection of wafer defects using an optical intensity measuring device 80 as the optical detecting unit is shown. In this embodiment, the optical intensity measuring device detects the reflection 74 from the surface of the desired wafer 15, generated by the illumination of the inspection light 72 from at least one light source 70, to obtain reflection intensity (or wavelength) information. Through comparisons between the reflection intensity (wavelength) information and the corresponding reference information, whether or not the desired wafer is abnormal can be detected instantaneously.

An apparatus 60 for real-time detection of wafer defects shown in FIG. 3 includes a wafer disposition portion 20 to dispose a desired wafer 15 for detection, at least one light source 70 for illuminating an inspection light 72 onto the desired wafer 15, an optical intensity measuring device 80 and a process control unit 40. According to requirements, the apparatus 60 for real-time detection of wafer defects further has an alarm trigger 50, and through connection lines 42 respectively connects the light source 70, the optical intensity measuring device 80 and the alarm device 50 with the process control unit 40.

Next, a desired wafer 15 for detection is disposed on the wafer disposition portion 20 and the wafer disposition portion 20 can be, for example, a platform disposed on a measuring device or a stocker. The desired wafer 15 is then illuminated by an inspection light 72 at a predetermined angle by the light source 70. When the inspection light 72 illuminates the desired wafer 15, a portion of the inspection light 72 is absorbed and reflects a reflection 74. The light source 70 can be, for example, a laser source such as a focused laser source. The focused laser source can achieve higher focused beams and more precise orientation for assisting the optical intensity measuring device 80 to precisely sense the intensity variations of the reflection 74.

Next, intensity variations of the reflection 74 are gathered by the optical intensity measuring device 80. The optical intensity measuring device 80 can be, for example, a laser sensor such as a flat type laser sensor constituted by a plurality of photosensitive diodes of two-dimensional arrangements to sense the intensity and location information thereon.

When the intensity variations of the reflection 74 on the desired wafer 15 are gathered by the optical intensity measuring device 80, the gathered intensity variations is then transferred to the process control unit 40 for comparison with corresponding reference information and analysis thereof can be performed instantaneously to determine whether or not the desired wafer is abnormal.

The apparatus 60 for real-time detection of wafer defects of the invention can further include an alarm trigger 50 connected to the process control unit 40 to sound an alert signal when an abnormal wafer is detected. The alarm trigger 50 can be a warning tower or a buzzer.

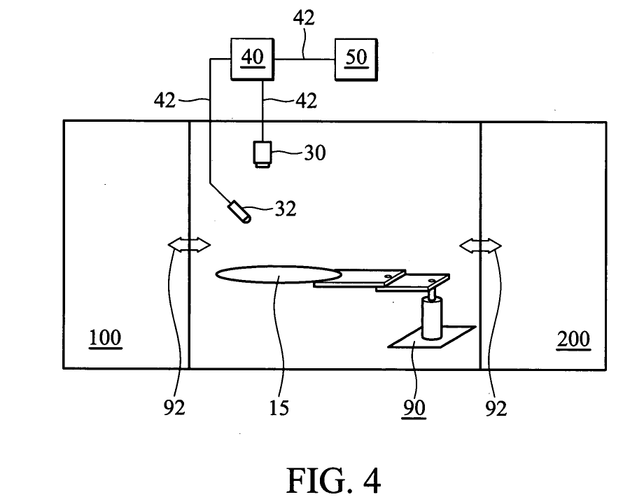

The apparatus 60 for real-time detection of wafer defects of the invention can be further connected in combination with a semiconductor manufacturing apparatus or directly integrated to accomplish successive step manufacturing. In FIG. 4, an apparatus for real-time detection of wafer defects integrated between a loading chamber 100 and a process chamber 200 is illustrated. The wafer can be detected by the real-time detection apparatus of the invention before or after any fabrication step to achieve instantaneous abnormality detection and the transfer unit 90 can be used to measure as well as transport.

The main advantage of the method and the apparatus for real-time detection of wafer defects in accordance with the invention include the detection of abnormal wafers caused by manufacturing apparatuses or mistakes detected previous to system damage and the ability to take predetermined action to prevent errors in subsequently performed fabrication during successive type semiconductor fabrication. Damage to the manufacturing apparatuses, down time and excessive process costs are thus prevented.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for real-time detection of wafer defects, comprising the steps of:
providing a desired wafer before or after a predetermined fabrication step and obtaining optical information thereof; and
comparing and analyzing the optical information of the desired wafer with corresponding reference information for instantaneously detecting possible wafer defects, wherein a predetermined action is performed upon detection of wafer defects.

2. The method as claimed in claim 1, wherein an optical detecting unit is used to detect the desired wafer and obtaining optical information thereof, and a process control unit is used for analyzing the optical information of the desired wafer.

3. The method as claimed in claim 2, wherein the optical detecting unit is an image capture device.

4. The method as claimed in claim 3, wherein the image capture device is constituted by at least one charge-coupled device (CCD) to gather film color information of the desired wafer.

5. The method as claimed in claim 4, wherein the film color information is compared with corresponding reference film color information to instantaneously determine whether wafer defects are present.

6. The method as claimed in claim 2, further comprising the step of illuminating the desired wafer with an inspection light during the step of obtaining optical information about the desired wafer.

7. The method as claimed in claim 6, wherein the optical detecting unit is an optical intensity measuring device for gathering reflection intensity information from the inspection light illuminating the desired wafer.

8. The method as claimed in claim 7, wherein the reflection intensity on the desired wafer is compared with a corresponding reference light intensity to instantaneously determine whether defects are present.

9. The method as claimed in claim 2, wherein the predetermined action comprising the step of halting the subsequent fabrication steps of the desired wafer.

10. The method as claimed in claim 2, wherein the predetermined action comprises the step of triggering an alarm trigger to sound an alert signal.

11. A device for real-time detection of wafer defects, comprising:
an optical detection device for detecting defects in a desired wafer after different processes or before processing for gathering optical information thereof; and
a process control unit for comparing and analyzing the optical information with corresponding reference information to instantaneously detect possible wafer defects, wherein a predetermined action is performed by the process unit when detecting possible wafer defects.

12. The device as claimed in claim 11, wherein the detection unit is an image capture device.

13. The device as claimed in claim 12, wherein the image capture device is constituted by at least one charge-coupled device (CCD) to gather film color information of the desired wafer.

14. The device as claimed in claim 13, wherein the film color information is compared with corresponding reference film color information to instantaneously differentiate whether defects are detected.

15. The device as claimed in claim 11, further comprising at least one light source to illuminate the desired wafer with an inspection light.

16. The device as claimed in claim 15, wherein the optical detecting unit is an optical intensity measuring device for gathering reflection intensity information form the inspection light illuminating the desired wafer.

17. The device as claimed in claim 16, wherein the process control unit compares the reflection intensity with a corresponding reference light intensity to instantaneously determine whether possible defects are present.

18. The device as claimed in claim 11, wherein the predetermined action performed by the process control unit comprises the step of halting the subsequent process steps of the desired wafer when possible wafer defects are detected.

19. The device as claimed in claim 11, further comprising an alarm trigger to sound an alert signal by the process control unit when possible wafer defects are detected.
